(19) United States
(12) Patent Application Publication
(10) Pub. No.: US 2016/0259825 A1
(43) Pub. Date: Sep. 8, 2016

(54) DISCOVERY OF POTENTIAL PROBLEMATIC EXECUTION PLANS IN A BIND-SENSITIVE QUERY STATEMENT

(71) Applicant: DELL PRODUCTS L.P., Round Rock, TX (US)

(72) Inventors: Wai Yip To, Yaumatei (HK); Ka Wing Ellis Luk, Chennai (IN)

(73) Assignee: DELL PRODUCTS L.P., Round Rock, TX (US)

(21) Appl. No.: 14/640,706

(22) Filed: Mar. 6, 2015

(51) Int. Cl. G06F 17/30

(52) U.S. Cl. CPC G06F 17/30463; G06F 17/30477; G06F 17/30867

(57) ABSTRACT

Aspects of the present invention provide systems and methods that can help generate potential execution plans for a query statement that have one or more bind variable, whether the one or more bind variables were originally in the query statement or replaced one or more literals in the query. Embodiments of the present invention also include systems and methods for testing performance of one or more of the potential execution plans before they emerge in the production environment.

### A. TECHNICAL FIELD

The present disclosure relates to systems and methods for improved data processing using one or more information handling systems.

### B. DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Related to the expansion of information is the maintenance and use of databases to store and access information. The amount of data collected, stored, and analyzed has rapidly increased and increased at near exponential levels. Because of the vast amounts of data and database usage, it is important that the queries run on databases be done efficiently. To help with efficiency, query execution plans may be formed.

One factor that affects a database optimizer when determining an execution plan for a Structured Query Language (SQL) query, statement, or code is the selectivity of a condition (or multiple conditions) in the SQL. When a condition eliminates most of the rows from its row source, it is said that this condition has a high selectivity and this makes the condition a good candidate to use an index to search for the data.

To help improve query performance, bind variables may also be used. Bind variable are a mechanism by which to pass data to the database. Instead of putting the query values directly into the SQL statement, a placeholder (i.e., a bind variable) may be used. Presented below is an example of a SQL statement with one bind variable:

select *
from EMPLOYEE
where EMP_ID<:VAR_ID

A database optimizer might use bind peeking technique to evaluate the actual values of bind variables to determine selectivity and hence determine the execution plan. In the example above, if the bind value of variable “:VAR_ID” is a large number, the database optimizer may conclude that using an index to retrieve data from the EMPLOYEE table is not worthwhile and therefore may use a full table scan operation instead. This type of SQL statement with execution plan that changes according to actual bind values during execution is called a bind-sensitive SQL statement.

It should also be noted that a bind-sensitive SQL statement is not limited to a SQL statement with bind variables. A database may internally convert literals in a SQL statement into bind variables, such as in the case of Cursor Sharing in Oracle systems of Oracle Corporation, Redwood Shores, Calif. For example, a SQL statement with a literal value like this:

select *
from EMPLOYEE
where EMP_ID<10000

or this:

select *
from EMPLOYEE
where EMP_ID<9

may actually be converted to another SQL statement with a bind variable replacing the literal when executed:

select *
from EMPLOYEE

where EMP_ID<:SYS_B_0

So, in the end there will be only one SQL statement with a bind variable to be shared by the two original SQL statements using literal 10000 and literal 9. This final form of SQL statement that the database uses may be a bind-sensitive SQL itself.

In today's database market, a database vendor may identify a SQL statement as bind-sensitive and even keep a list of different execution plans that have been generated for different executed bind values. However, there is no easy way for users to see all or most of the potential plans. Even worse, there is no guarantee that potential bind-sensitive plans are always good in performance due to the complexity in SQL statements (e.g., where more than one bind variable is present) and limitations in a database optimizer.

Accordingly, what is needed are systems and methods that can explore potential execution plans for a bind-sensitive SQL statement and test their performance before they emerge in the production environment.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 (“FIG. 1”) depicts a methodology for generating and checking potential plans according embodiments of the present invention.

FIG. 2 depicts an example method using statistics to generate bind variable values according to embodiments of the present invention.

FIG. 3 depicts an example method of using sampling to obtain values for one or more bind variables according to embodiments of the present invention.

FIG. 4 depicts an example method of using user input to generate bind variable values according to embodiments of the present invention.

FIG. 5 depicts an example system for automatic discovery of potentially problematic execution plans in a bind-sensitive SQL statement according to embodiments of the present invention.

FIG. 6 depicts a simplified block diagram of an information handling system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that: (1) certain steps may optionally be performed; (2) steps may not be limited to the specific order set forth herein; (3) certain steps may be performed in different orders; and (4) certain steps may be done concurrently.

Examples provided here are described in terms of SQL statements, but it shall be noted that aspects of the present invention may be applied to other query statements.

### A. INTRODUCTION

Currently, there are no existing solutions available in the market that optimizes bind-sensitive SQL statements. Instead, optimizing a bind-sensitive SQL statement relies on human effort. For example, a database administrator (DBA) may know if a SQL statement is bind-sensitive. He or she can then try a few common bind values, test their performance, and hope that a bad plan will not be used in the production environment.

Accordingly, aspects of the present invention relate to systems and methods that can automatically explore potential execution plans for a bind-sensitive SQL statement and test their performance before they emerge in the production environment. In embodiments, the solutions presented herein help resolve the challenge by proactively attempting to identify potentially problematic execution plans for a bind-sensitive SQL statement, to help identify good execution plans, or both.

### B. GENERAL METHODOLOGY

In embodiments, a key issue is how to explore all, or a significant number of, potential execution plans. Since the bind values are the factor that causes different execution plans to be derived in a bind-sensitive SQL, what is need are methods that can generate different bind values to evaluate. For each set of bind values generated, these values may be associated with the SQL statement and the SQL statement may be sent to the database to evaluate if a new execution plan would be derived. When enough different values have been evaluated to cover a range of possible bind values, it can be said that most or all potential plans have been covered.

For example, given this SQL:

select *
from EMPLOYEE

where EMP_ID<:var1
and EMP_DEPT=:var2

The algorithm may try to evaluate the SQL statement using different sets of bind values as shown below:

TABLE 1

| | :var1 | :var2 |
|---|---|---|
| Test 1 | 9999999 | ‘ACC’ |
| Test 2 | 9999999 | ‘ZOO’ |
| Test 3 | 1 | ‘ACC’ |
| Test 4 | 1 | ‘ZOO’ |

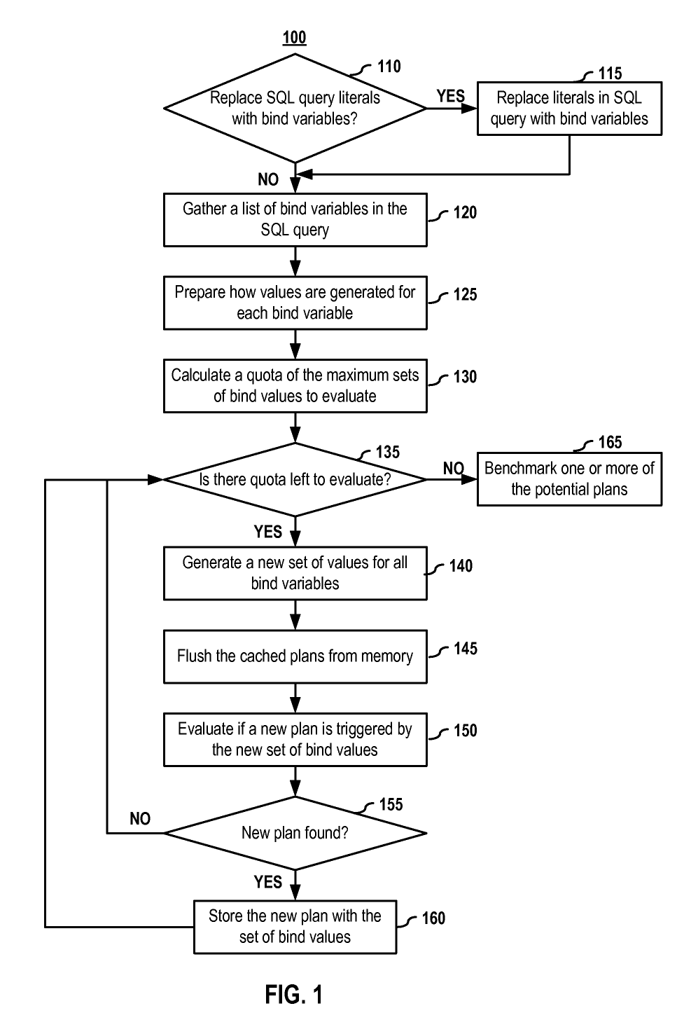

FIG. 1 depicts a methodology 100 for generating and checking potential plans according embodiments of the present invention.

1. Replacing Literals in SQL Statement with Bind Variables

As show in FIG. 1, in embodiments, a check may be made to determine (110) whether to replace SQL query literals with one or more bind variables. Thus, it shall be noted that, in embodiments, this methodology may be used against SQL statements with literals as well. In embodiments, if the connecting database supports converting literals into bind variables, the literals may be replaced (115) with bind variables before evaluating the different bind values. Thus, it shall be noted that a “bind-sensitive query statement” may be one that originally contained literals which were converted to one or more bind variables or may be one that originally contained one or more bind variables.

For example, this SQL with literals:

select *
from EMPLOYEE

where EMP_ID<120000
and EMP_DEPT=‘ACC’

may be changed to the following SQL with bind variables:

select *
from EMPLOYEE

where EMP_ID<:SYS_B_0
and EMP_DEPT=: SYS_B_1

However, it shall be noted that embodiments of the present invention may not involve replacing SQL literals or may not decide to replace the SQL literals.

2. Gathering a List of Bind Variables in the SQL Statement

In any event, in embodiments, the process proceeds by gathering (120) or retrieving a set of one or more bind variables in the SQL statement. For example, given this SQL statement:

select *
from EMPLOYEE

where EMP_ID<:var1
and EMP_DEPT=:var2

the following set of bind variables are retrieved:

(:var1, :var2)

3. Prepare how Values are Generated for Each Bind Variables

In embodiments, for each bind variable that was retrieved, information is gathered about how values can be generated for that bind variable. In embodiments, at least three basic ways exists to generate values:

(a) Based on database statistics (e.g. histogram);

(b) Sampling of real data; and

(c) Randomly generating within a user-specified range.

It shall be noted that these three basic approached may be used independently or may be used in various combinations. Descriptions of embodiments of each of these approaches are provided below.

a) Based on Database Statistics

In embodiments, if statistics or histograms are available for data, such as a column or other portion of a database, which is associated with a bind variable in a predicate, then these statistics/histograms may be used to generate values for that bind variable. Consider, by way of example, the following SQL statement:

select *
from Table1

where Col1=:var1

The statistic values for Col1 in the database may be used to generate different values for the bind variable :var1. Presented below are some examples of different statistic values for column Col1 that may be used:

TABLE 2
EXAMPLE STATISTICS

| Statistic Value | Notation |
|---|---|
| Minimum value of Col1 | MinVal(Col1) |
| Medium value of Col1 | MedVal(Col1) |
| Maximum value of Col1 | MaxVal(Col1) |
| The most unique value of Col1 | MostUnq(Col1) |
| The medium unique value of Col1 | MedUnq(Col1) |
| The least unique value of Col1 | LeastUnq(Col1) |

It shall be noted that there may be more than one column associated to the same bind variable. Consider, by way of example, the following SQL statement:

select *
from Table1, Table2, Table3, Table4

where Table1.Col1=:var1
and Table2.Col2=:var1
and Table2.Col2=Table3.Col3
and Table3.Col3=Table4.Col4

Thus, Col1, Col2, Col3, and Col4 are considered to be associated with the bind variable :var1. Therefore, for this example, the followings are all possible values from database statistics that may be used to generate values for bind variable :var1:

MinVal(Col1), MedVal(Col1), MaxVal(Col1), MostUnq(Col1), MedUnq(Col1), LeastUnq(Col1),

MinVal(Col2), MedVal(Col2), MaxVal(Col2), MostUnq(Col2), MedUnq(Col2), LeastUnq(Col2),

MinVal(Col3), MedVal(Col3), MaxVal(Col3), MostUnq(Col3), MedUnq(Col3), LeastUnq(Col3),

MinVal(Col4), MedVal(Col4), MaxVal(Col4), MostUnq(Col4), MedUnq(Col4), LeastUnq(Col4)

Thus, in embodiments, using this technique, a list of possible statistic values for each bind variable may be built, and a value-generating function may be created (called it, for example, GetValueFromStat) that takes a bind variable name as its input and randomly return one of the possible statistic values for that bind variable. Consider, by way of example, the following:

GetValueFromStat (BindVarName)->Statistic_Value

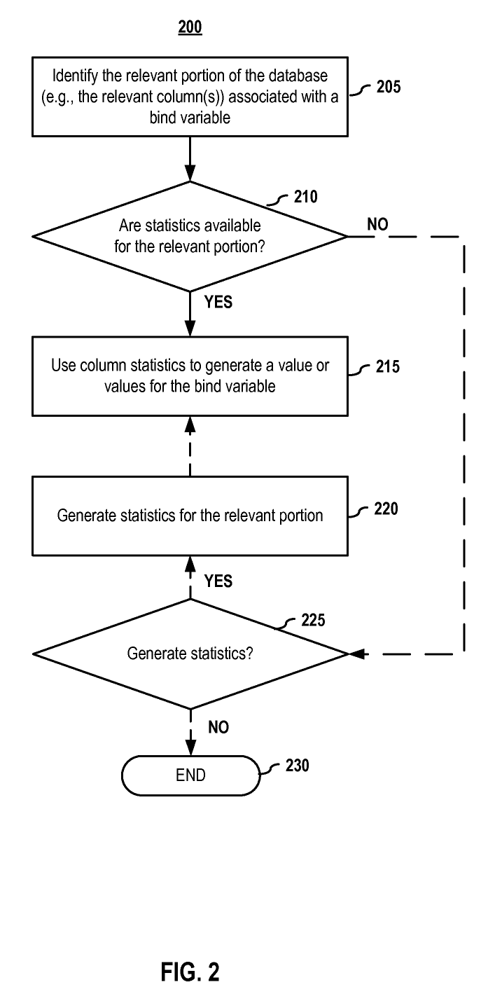

FIG. 2 depicts an example method of using statistics to generate bind variable values according to embodiments of the present invention. As shown in FIG. 2, the relevant portions of the database (e.g., column(s)) associated with a bind variable are identified (205) and a check is made (210) to determine whether or not statistics are available. If statistics are available for the relevant portion, the column statistics/histograms may be used (215) to generate a value or values for the bind variable.

However, in embodiments, if statistics are not available for the relevant portion, a determination may be made (225) whether or not to generate statistics. If statistics are desired, the statistics/histogram(s) for the relevant portion may be generated (220). Because generating statistics/histogram(s) may not always be possible or practical, it may be determined not to generate statistics/histogram(s), at which point the process ends (230).

b) Sampling of Real Data

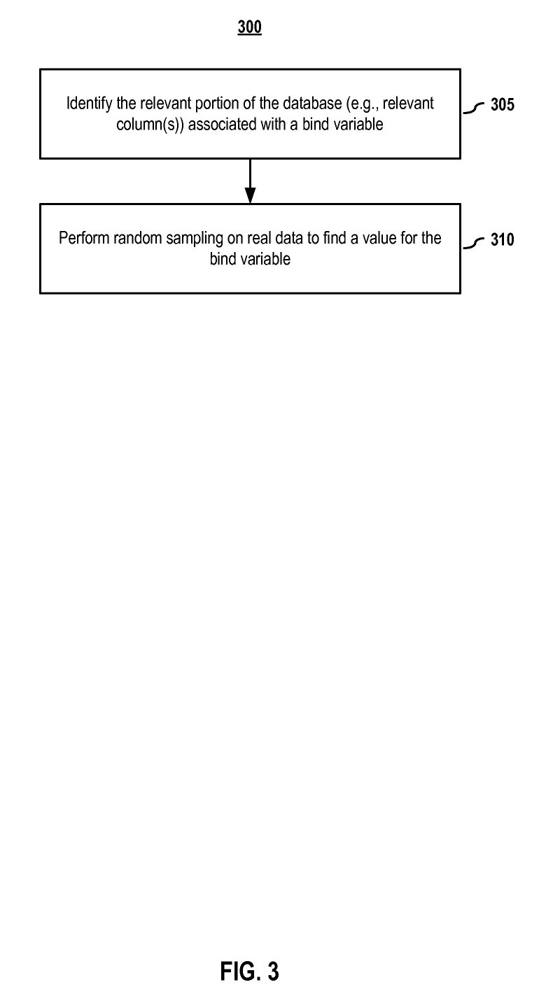

In embodiments, sample of data may be used. FIG. 3 depicts an example method of using sampling to obtain values for one or more bind variables according to embodiments of the present invention. As in the case of examining statistic data in the database, embodiments of this approach find (305) the portion of the databases (e.g., column or columns) that are associated with a bind variable in a predicate. Once the portion has been identified, a SQL statement may be used to perform random sampling (310) on the real data to find possible values to use. It should be noted that random sampling query is supported in most databases and below is an example SQL statement in Oracle:

select Col1
from Table1 SAMPLE (1)

where rownum=1

This SQL statement will perform a sampling on one percent of the rows in the table and return the first row. If the SQL statement is executed again, another sampling of one percent of the rows will be done and will return another sampling data from the table.

As explained before, there can be multiple columns associated with the same bind variable. So in such cases, sampling of real data in different columns in different tables may also be done to generate bind values. Once all the associated columns for each bind variables have been identified, another value-generating function (called it, for example, GetValueFromRealData) can be created that takes a bind variable name as its input and randomly choose one of its associated columns to execute the related sampling SQL to get a value, such as:

GetValueFromRealData (BindVarName)->Real Data Value

One skilled in the art shall recognize that other sampling may also be performed and falls within the current disclosure. It shall also be noted that this approach to sample real data may be done even if histograms do not exist for the relevant column(s).

c) Randomly Generating within a User-Specified Range

It should be noted that not all bind variables are directly comparing a column in a predicate. There could be calculation on the bind variable or on a portion of the data. Consider, by way of illustration, the following two examples:

### Example 1

select *
from Table1

where Col1=(:var1−10)*2

### Example 2

select *
from Table1

where Col1+Col2=:var1

In such cases, approaches of examining database statistics data or sampling real data may not be applicable to generate values for this bind variable. Accordingly, user intervention is desirable in such instances.

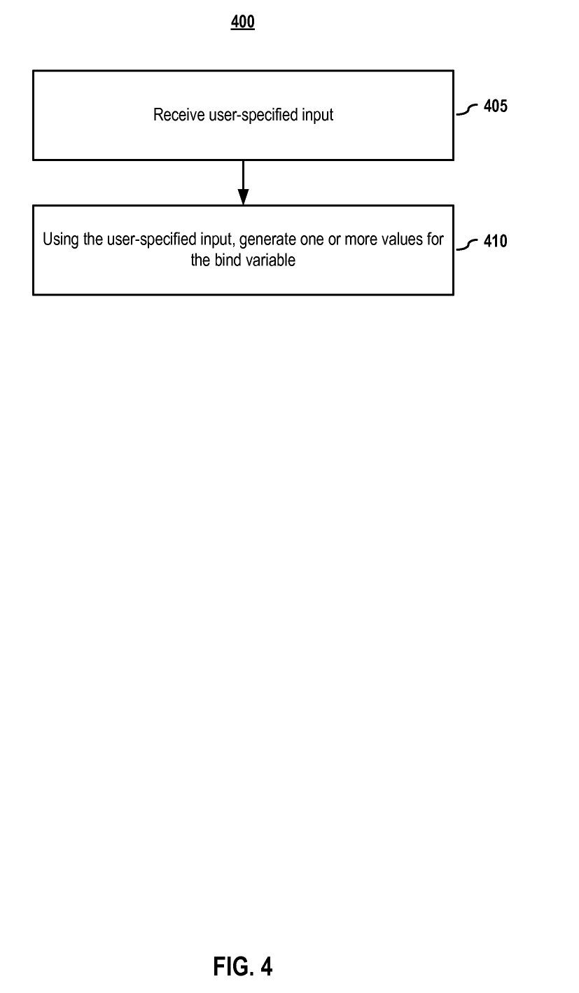

FIG. 4 depicts an example method of using user input to generate bind variable values according to embodiments of the present invention. As shown in FIG. 4, the user specifies (405) or otherwise indicates one or more parameters (e.g., a value or set of values). In embodiments, users may control what values to use for this type of bind variables by: (1) providing a list of possible values (e.g., 10, 25, 50, 80, 120); (2) providing a range (e.g., between 10 and 120); and/or (3) providing a statement by which values may be obtained.

With this information, a possible value may be chosen from the list or one may be generated (e.g., by selecting one or more from the specified range). This value or values may then be evaluated (410) to obtain bind values. In embodiments, a value-generating function may be created (called it, for example, GetValueFromUserDefinedRange) that will return (410) a possible value for a given bind variable given the user-specified input, like this:

GetValueFromUserDefinedInput (BindVarName)->Generated_Value

It shall be noted that, in embodiments, other bind values may be included into the user-defined parameter(s) to evaluate. For example, when literals are replaced with bind variables, the original literal values may be automatically included in the list of values to try.

4. Calculating a Quota of the Maximum Sets of Bind Values to Evaluate

When there are only a few bind variables in a SQL statement, it would be easy to create all possible combinations of bind values to evaluate. However, when there are more bind variables (e.g., 10 or more variables), creating all combinations becomes infeasible. Thus, in embodiments, a quota may be calculated (step 130, FIG. 1) for the evaluation process.

In embodiments, a limit on the quota may be determined as follows:

Let MaxP (which may be set at a default of 5000, but could be set at other default values) be the user-defined maximum for the number of times to evaluate

Let N be the number of variables in the SQL statement

Let F (which may be set at a default of 2, but could be set at other default values) be an internally configurable parameter used to increase the searching quota

Then Quota=MIN(POWER(6, N)*F, MaxP)

It shall be noted that this approach for limiting the quota is only one example formula that may be used. One skilled in the art shall recognize: (1) that the current disclosure is not limited to this formula; (2) that other approaches may be used; and (3) that these other approaches fall within the scope of the current document.

5. Generate a New Set of Values for Bind Variables

Returning to FIG. 1, in the earlier process, enough information has been prepared for generating values for each bind variable. For example, the three functions described above, namely GetValueFromStat, GetValueFromRealData, GetValueFromUserDefinedlnput, are ready to be used. Thus, as long as there is still quota left (135) to be evaluated (i.e., the quota has not been exhausted), one or more of these functions or other functions may be called to generate (140) values for each bind variable. In embodiments, every time a new set of bind values may be created (140) to evaluate the SQL statement. For example, in embodiments, a new set of values for at least one of the one or more bind variables may be obtained for each iteration.

It shall be noted that some bind variables may only use one of the functions to generate values but some bind variables may use some or all of these functions. In embodiments, the present algorithm may be configured to use different value-generating functions in different situations. Additionally or alternatively, in embodiments, it may be set to randomly choose one of the functions to generate values.

6. Flush Cached Plans from Memory

In embodiments, a purpose of the evaluation process is to discover potential execution plans due to different bind values used. In embodiments, to see if a new plan is derived when a new set of bind values are used, the cached plan are flushed (145) from memory. Because a database optimizer may try to reuse a cached plan in certain situations, flushing the cached plans from a cache memory helps ensure that the database optimizer will evaluate the SQL anew and take into account the current bind values used.

It should be noted that the exact way to flush a cached plan from memory depends on the database vendor. Some database vendors may support flushing the cached plans associated with a particular SQL statement and some vendors may require flushing the memory for all SQL statements. In embodiments, it is preferred to limit the impact by flushing the cached plans for only a particular SQL statement whenever possible.

7. Evaluate if a New Plan is Triggered by the New Set of Bind Values

Once the cached plans are flushed and the database system is ready to evaluate the SQL statement anew, the SQL statement is submitted to the database system once again but using a different set of bind values. In embodiments, it is determined (150) whether the database derives a new execution plan for the new set of bind values. In embodiments, all the unique execution plans that have been derived for this SQL statement are stored so that it can compare the current plan with the stored ones to identify any new execution plan. In embodiments, this evaluation process may be simply to get a plan for the SQL statement, or it may require a full test run of the SQL statement.

8. Store the New Plan with the Set of Bind Values

Responsive to a new plan being generated (155), this new plan may be stored together with the set of bind values (160) that was used to trigger the new plan. Further analysis or benchmarking may be done on this plan when needed.

In embodiments, if a new plan is not found (155) or if a new plan has been found and stored, the process may repeat, or iterate, by returning to step 135 to determine whether more quota exists to be evaluated. If there are more test quota values, the process repeats. However, if all the test quota have been evaluated (i.e., the quota has been exhausted), the potential plans that were obtained may be benchmarked (165).

9. Benchmark Potential Plans

In embodiments, after the evaluation process, a list of potential plans for the bind-sensitive SQL statement and also the sets of bind values that triggered the different plans exists.

Consider, by way of illustration, an example of a SQL statement with two bind variables and three unique plans that were found:

SQL:

select *
from EMPLOYEE

where EMP_ID<:var1
and EMP_DEPT=:var2

Potential Plans found:

| | Set of bind values that |
|---|---|
| Unique plan found | triggered the new plan |
| Plan 1 | :var1 = 1 |
| | :var2 = ‘TMP’ |
| Plan 2 | :var1 = 9000 |
| | :var2 = ‘ACC’ |
| Plan 3 | :var1 = 732245 |
| | :var2 = ‘HR’ |

In embodiments, various benchmarking methods may be employed on at least some of the stored unique plans. Two examples of benchmarking methods include: (1) standard bind sensitive benchmarking; and (2) cross-checking benchmarking.

a) Standard Bind Sensitive Benchmarking Method

In embodiments, using this methodology, the SQL is run as-is but using different bind values each time. In embodiments, the different sets of bind values to use are the ones that triggered the different execution plans. Therefore, using the above example, the following testing may be performed:

| Unique plan found | Bind values to use |
|---|---|
| SQL as-is | :var1 = 1 |
| | :var2 = ‘TMP’ |
| SQL as-is | :var1 = 9000 |
| | :var2 = ‘ACC’ |
| SQL as-is | :var1 = 732245 |
| | :var2 = ‘HR’ |

In embodiments, this approach allows the database to use its bind sensitive feature to execute the SQL statement. It means that the database may choose different execution plans according to the bind values used. In embodiments, the benchmark results will reflect if the database has reacted to the bind values promptly and there is no delay in the database in switching plans.

In embodiments, after the testing, users are able to see the following data in each plan:
The set of bind values that triggered the plan and used to test;
Number of records returned;
Execution time (response time, total elapsed time, and other run-time statistics available); and
Average time per record (which may be calculated as “Execution time”/“Number of records returned”).

It shall also be noted that the execution time measured for these execution plans may be very different. Since the plans are tested using different sets of bind values, some plans may return more records than the other plans in the testing and hence their execution time could be longer. In embodiments, the “Average time per record” serves as a convenient way to compare the performance of different plans in this scenario. Alternatively, users may also look at the “Number of records returned” and the “Execution time” together to determine if any plans are problematic. It shall be noted that other information may also be monitored and made available to users.

In embodiments, users may additionally submit their own set of bind values to test so they can evaluate how the SQL statement reacts to their particular set of bind values.

b) Cross-Checking Benchmarking Method

In embodiments, users may test run a particular execution plan and ascertain its performance against different sets of bind values. In embodiments, the bind values used are not necessarily the ones that triggered the execution plan under test. That is, in embodiments, this testing would involve running the SQL statement using a particular plan and forbidding the database from switching plans according to the bind values.

Most databases provide a mechanism to specify the execution of a SQL statement to use a particular execution plan (e.g., specifying Outline data in an Oracle database). Using these techniques, the SQL may be run using a particular plan during testing with different sets of bind values. For example, if users want to use the SQL statement with bind sensitive Plan 2 in the above example, the following testing may be performed:

| SQL to run | Bind values to use |
|---|---|
| SQL using Plan 2 | :var1 = 1 |
| | :var2 = ‘TMP’ |
| SQL using Plan 2 | :var1 = 9000 |
| | :var2 = ‘ACC’ |
| SQL using Plan 2 | :var1 = 732245 |
| | :var2 = ‘HR’ |

In embodiments, a purpose of this cross-checking benchmarking is to help users simulate the potential performance problem of a database not reacting to the bind values, in which the user may try to generate a new bind sensitive plan and/or may delay the use of the generated bind sensitive plan.

In embodiments, users may submit their own set of bind values to test when using this method. Therefore, they can find out how a particular plan performed when their particular set of bind values is used.

### C. SYSTEM EMBODIMENTS

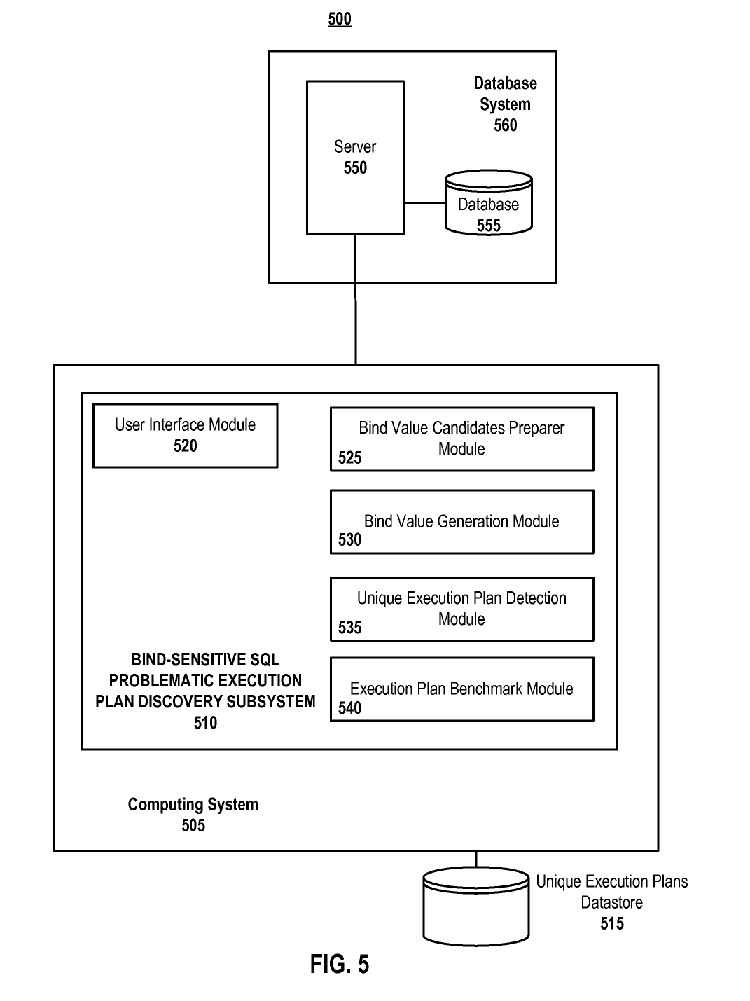

FIG. 5 depicts an example system for discovery of potentially problematic execution plans in a bind-sensitive SQL statement according to embodiments of the present invention. Shown in FIG. 5 are a computing/information handling system 505 that comprises a bind-sensitive SQL problematic execution plan discovery subsystem or module 510 and one or more storage elements 515 and it communicatively coupled to a database system 560.

In embodiments, the bind-sensitive SQL problematic execution plan discovery module 510 comprises a number of modules. These modules may include a user interface module 520, bind value candidates preparer module 525, bind value generation module 530, unique execution plan detection module 535, and an execution plan benchmark module 540. In embodiments, each of these modules performs a subset of the functions described above.

In embodiments, the user interface module 520 is configured to facilitate interactions between the system 505 and a user. In embodiments, the interface 520 may be used to receive one or more inputs from a user and may be used to present one or more outputs to the user. For example, using one or more interfaces, the user may supply bind value candidates or may view results of benchmarking via the interface module 520.

Not shown in FIG. 5 is a database optimizer, which may be part of a database system 560. In embodiments, the database optimizer may parse a SQL statement and identify the bind variable. Also, a database optimizer may be used to convert literals in the original query into bind variables, convert bind variables to bind values, may run test bind value of SQL plans, and may perform other functions as described herein and/or that are common to database optimizers.

In embodiments, the bind value candidates preparer module 525 may be configured to perform the step of preparing how values are generated, including without limitation selecting or receiving input regarding how bind values are obtained. In embodiments, the preparer module may also determine a quota.

In embodiments, the unique execution plan detection module 535 may be configured to perform or coordinate the performance of steps 140-160 of FIG. 1. For example, in embodiments, the unique execution plan detection module 535 may include or interface with one or more modules, such as bind value generation module 530, to obtain the bind values. In embodiments, the bind value generation module 530 may perform the functions described above, namely GetValueFromStat, GetValueFromRealData, GetValueFromUserDefinedInput, to obtain values by accessing data in a database 555.

In embodiments, as execution plans are obtained, they may be stored in a datastore 515 that is communicatively coupled to the subsystem 510. When execution plan detection module generates a plan during an iteration, it can access the stored plans to determine whether the currently generated plan is unique.

Also, once the execution plans have been generated, the execution plan benchmark module 540 may access the plans and benchmark the one or more of the plans for potential issues as previously discussed.

It should be noted that aspects of the present patent document are directed to information handling systems. For purposes of this disclosure, an information handling system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

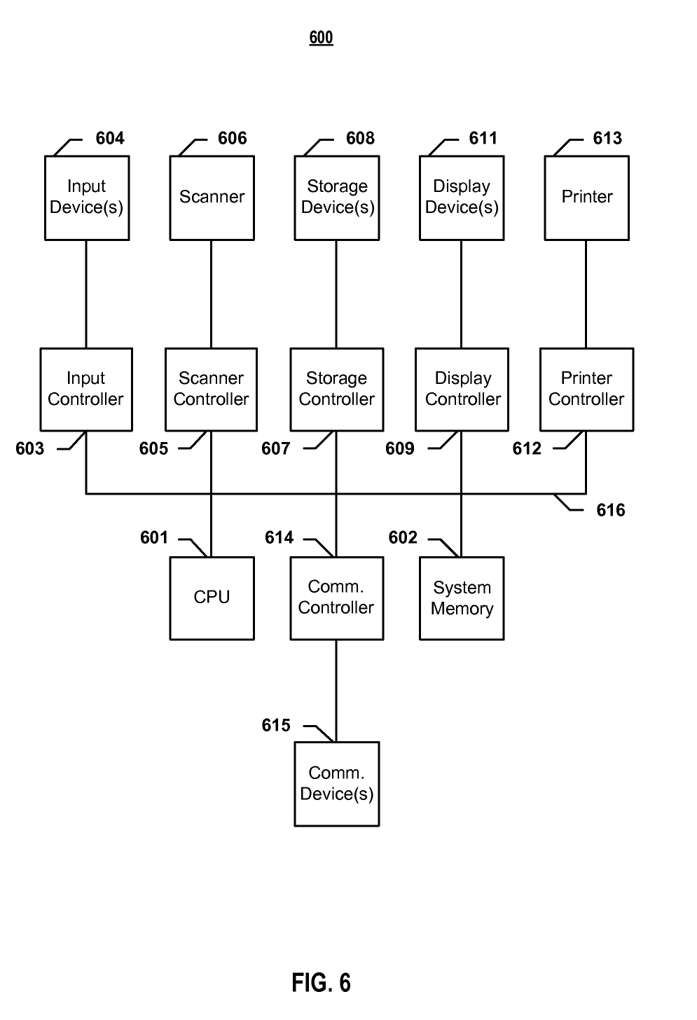

FIG. 6 depicts a block diagram of an information handling system 600 according to embodiments of the present invention. It will be understood that the functionalities shown for system 600 may operate to support various embodiments of an information handling system—although it shall be understood that an information handling system may be differently configured and include different components. As illustrated in FIG. 6, system 600 includes a central processing unit (CPU) 601 that provides computing resources and controls the computer. CPU 601 may be implemented with a microprocessor or the like, and may also include a graphics processor and/or a floating point coprocessor for mathematical computations. System 600 may also include a system memory 602, which may be in the form of random-access memory (RAM) and read-only memory (ROM).

A number of controllers and peripheral devices may also be provided, as shown in FIG. 6. An input controller 603 represents an interface to various input device(s) 604, such as a keyboard, mouse, or stylus. There may also be a scanner controller 605, which communicates with a scanner 606. System 600 may also include a storage controller 607 for interfacing with one or more storage devices 608 each of which includes a storage medium such as magnetic tape or disk, or an optical medium that might be used to record programs of instructions for operating systems, utilities and applications which may include embodiments of programs that implement various aspects of the present invention. Storage device(s) 608 may also be used to store processed data or data to be processed in accordance with the invention. System 600 may also include a display controller 609 for providing an interface to a display device 611, which may be a cathode ray tube (CRT), a thin film transistor (TFT) display, or other type of display. The computing system 600 may also include a printer controller 612 for communicating with a printer 613. A communications controller 614 may interface with one or more communication devices 615, which enables system 600 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A computer-implemented method for discovery of one or more execution plans for a bind-sensitive query statement comprising:
for each bind variable from a set of one or more bind variables identified in a bind-sensitive query statement, preparing how values are to be generated for the bind variable;
calculating a quota for evaluating the bind-sensitive query statement; and
performing the following steps while the quota is not exhausted:
generating a new set of bind values for at least one bind variable from the set of one or more bind variables;
evaluating whether a new execution plan is generated by a database system by the new set of bind values; and
responsive to a new execution plan being generated, storing the new execution plan with the set of bind values in a memory.

2. The computer-implemented method of claim 1 further comprising:
flushing any cached execution plans from a cache memory of the database system in each iteration of the quota evaluation.

3. The computer-implemented method of claim 1 further comprising:
responsive to the quota being exhausted, benchmarking at least some of the stored new execution plans.

4. The computer-implemented method of claim 3 further comprising:
responsive to identifying a new execution plan that has an acceptable performance, selecting the new execution plan.

5. The computer-implemented method of claim 1 wherein the step of preparing how values are to be generated for the bind variable comprises:
gathering information about how values may be generated for a bind variable by evaluating which of a set of methods may be used to obtain values for the bind variable.

6. The computer-implemented method of claim 5 wherein the set of methods comprises:
using one or more database statistics related to at least some of the data associated with the bind variable;
sampling of data associated with the bind variable; and
using data associated with the bind variable and associated with one or more user-specified input parameters.

7. The computer-implemented method of claim 6 wherein the step of using one or more database statistics related to at least some of the data associated with the bind variable comprising:
identifying a relevant portion of a database that is associated with a bind variable;
ascertain whether statistics are available for the relevant portion of the database; and
using the statistics to generate a value or values for the bind variable.

8. The computer-implemented method of claim 1 wherein the step of generating a new set of bind values for at least one bind variable from the set of one or more bind variables comprises:
using, for each bind variable, one or more of methods from a set of methods that have been evaluated as being appropriate for the bind variable.

9. A system for discovering an execution plan for a bind-sensitive query statement, the system comprising:
one or more processors;
one or more memory components communicatively coupled to the processor;
an interface communicatively coupled to the processor that facilitates accessing one or more databases; and
a bind-sensitive query execution plan discovery subsystem that comprises:
a bind value candidates preparer module that, for each bind variables from a set of one or more bind variables identified in a bind variable query statement, gathers information about how a value or values may be generated for the bind variable by evaluating which of a set of methods may be used to obtain a value or values for the bind variable;
a bind value generation module that:
receives the bind variable query statement;
receives information from the bind value candidates preparer module comprising one or more methods for generating a bind value or values for one or more bind variables in the bind variable query statement; and
generates, for each iteration in a set of iterations, a new set of bind values for at least one bind variable from the set of one or more bind variables for use in generating an execution plan using the new set of bind values:
and
a unique execution plan detection module that, for each iteration from the set of iterations:
receives the generated execution plans;
determines whether the generated execution plan is unique; and
responsive to the generated execution plan being unique, stores in memory the generated execution plan to a unique execution plan datastore along with the new set of bind values associated with the generated execution plan.

10. The system of claim 9 wherein the bind-sensitive query execution plan discovery subsystem further comprises:
an execution plan benchmark module that benchmarks at least some of the generated execution plans in the unique execution plan datastore.

11. The system of claim 9 wherein the bind-sensitive query execution plan discovery subsystem is further configured to perform the step of:
flushing any cached execution plans from a cache memory.

12. The system of claim 9 wherein the bind-sensitive query execution plan discovery subsystem is further configured to perform the step of:
responsive to identifying an execution plan from the generated execution plans that has an acceptable performance, selecting the new execution plan for use with the bind variable query statement.

13. The system of claim 9 wherein the set of methods comprises:
using one or more database statistics related to at least some of the data associated with the bind variable;
sampling of data associated with the bind variable; and
using data associated with the bind variable and associated with one or more user-specified input parameters.

14. The system of claim 13 wherein the step of using one or more database statistics related to at least some of the data associated with the bind variable comprising:
identifying a relevant portion of a database that are associated with a bind variable;
ascertain whether statistics are available for the relevant portion of the database; and
using the statistics to generate a value or values for the bind variable.

15. The system of claim 13 wherein the bind-sensitive query execution plan discovery subsystem further comprises:
a user interface module that receives the one or more user-specified input parameters from a user.

16. A non-transitory computer readable medium or media comprising one or more sequences of instructions which, when executed by one or more processors, causes steps for discovery of one or more execution plans for a bind-sensitive query statement comprising:
for each bind variable from a set of one or more bind variables identified in a bind-sensitive query statement, preparing how values are to be generated for the bind variable;
calculating a quota for evaluating the bind-sensitive query statement; and
performing the following steps while the quota is not exhausted:
generating a new set of bind values for at least one bind variable from the set of one or more bind variables;
evaluating whether a new execution plan is generated by a database system by the new set of bind values; and
responsive to a new execution plan being generated, storing the new execution plan with the set of bind values in a memory.

17. The non-transitory computer readable medium or media of claim 16 further comprising:
flushing cached execution plans from a cache memory of the database system in each iteration of the quota evaluation.

18. The non-transitory computer readable medium or media of claim 16 further comprising:
responsive to the quota being exhausted, benchmarking at least some of the stored new execution plans; and
responsive to identifying a new execution plan that has an acceptable benchmark performance, selecting the new execution plan.

19. The non-transitory computer readable medium or media of claim 16 wherein the step of preparing how values are to be generated for the bind variable comprises:
gathering information about how values may be generated for a bind variable by evaluating which of a set of methods may be used to obtain values for the bind variable, the set of methods comprising:
using one or more database statistics related to at least some of the data associated with the bind variable;
sampling of data associated with the bind variable; and
using data associated with the bind variable and associated with one or more user-specified input parameters.

20. The non-transitory computer readable medium or media of claim 19 wherein the step of using one or more database statistics related to at least some of the data associated with the bind variable comprising:
identifying a relevant portion of a database that are associated with a bind variable;
ascertain whether statistics are available for the relevant portion of the database; and
using the statistics to generate a value or values for the bind variable.
